(19) United States
(12) Patent Application Publication
(10) Pub. No.: US 2007/0277901 A1
(43) Pub. Date: Dec. 6, 2007

(54) ProMix catalyzed aerosol paint

(76) Inventor: Brad Raether, Redmond, OR (US)

Correspondence Address: Brad Raether, Suite 201-307, 915 SW Rimrock Way, Redmond, OR, 97756, US

(21) Appl. No.: 11/801,278

(22) Filed: May 8, 2007

Related U.S. Application Data
(60) Provisional application No. 60/798,835, filed on May 8, 2006.

(51) Int. Cl. B65B 31/00; B67D 5/52

(52) U.S. Cl. 141/59; 222/136

(57) ABSTRACT

Aerosol Spray Paint Can wherein a separate container that holds catalyst is mounted inside. The container may be filled with a measured amount of catalyst after being installed in the outer can and easily actuated by the end user to release the catalyst from the container for thorough mixing with the paint contained within the outer can, therefore yielding an easy to use two-part paint from an aerosol can. The container includes several components, a cylinder that holds the catalyst and is secured between a base and retaining cap, a hollow shaft that contains a two-way valve and connects the base and retaining cap, a small handle or knob attached to the end of the shaft that extends out of the bottom of the can that can easily be turned to release the catalyst from the container at the time the contents of the can are to be used.

This application concerns an Aerosol Spray Paint Can with a separate container mounted inside that holds a measured amount of catalyst, and in particular, concerns novel configuration of the internally mounted Catalyst Container that allows the container to be filled once mounted inside the spray can and also facilitate a more thorough mixing of the catalyst with the surrounding paint. This application also concerns novel configuration for the end-user to easily release the contents from the Catalyst Container allowing the contents to be mixed with the paint held in the spray can at the time just before use, therefore yielding an easy to use two-part aerosol propelled spray paint.

### BACKGROUND OF THE INVENTION

Aerosol cans have long been known and widely used. Spray cans using aerosol as a propellant go back to the Second World War. Today the most common form of aerosol cans are a simple disposable or recyclable can that consists of a base, a top, a body and a simple press type valve for releasing the contents of the can. A lesser-used but common type of aerosol can has a bag or bladder mounted inside to keep the contents of the can and the aerosol propellant separate from each other. Though aerosol spray paints have achieved considerable popularity and commercial success, there has been a continuing need for a more durable two-part paint utilizing the simplicity and disposability of an aerosol can while being easy to use.

### SUMMARY OF THE INVENTION

Promix Catalyzed Aerosol Spray Paint

The invention may, in its broad sense, be defined as an Aerosol Spray Paint Can with a specially designed bottom to allow for a separate container to be mounted inside having a releasable cylinder containing a measured amount of catalyst. The improved structure concerns a novel design that allows the Catalyst Container to be filled once it is installed in the spray can while also evacuating the existing air out of container as it's being filled. The improved structure also concerns a novel design for the end-user to easily release the contents of the Catalyst Container for mixing with the paint that's held in the outer can. The Catalyst Container assembly is composed of several components cooperating together, a releasable cylinder that holds the catalyst, a hollow actuator shaft that contains a two-way valve that facilitates filling the container with catalyst while purging the existing air out at the same time and holds the cylinder between a retaining cap and base to keep the catalyst separate from the paint surrounding it until the time of usage, a t-nut or other type of handle or knob attached to the end of the actuator shaft that extends out of the bottom of the can that can be easily turned or twisted by the end-user to release the contents of the container for mixing with the paint at the time the contents are ready for use while keeping the rest of the Aerosol Spray Paint Can design and functions the same or close to the same as the well known and proven Aerosol Spray Paint Can technology of today.

Some important features of this container are as follows. The body or main cylinder of the container is held between a cap and a base that spread apart when the thumbscrew or knob is turned by the user which allows for the container to be open at both ends to facilitate a better mix of the catalyst into the paint by allowing the paint to flow through the open cylinder when the can is shaken for a short time. An important design feature of the main shaft that connects the retaining cap and base together also allows the user to open the container much easier. This is accomplished by having two different thread pitches in the cap and base with fewer threads per inch in the base than in the cap. This design allows for the shaft to move farther per turn through the base than the shaft turns into the cap. This thread pitch difference makes it much easier to overcome the internal pressure of a filled aerosol can by allowing the cap of the container to be pushed up at a reduced ratio of the shaft moving through the base while also allowing the cap to open without rotating therefore not having to overcome any friction from the seals between the cylinder and the cap and base. With less pressure needed to be exerted on the shaft to release the catalyst, it allows the actuation procedure to be much easier for the end-user to accomplish.

The top of the container is also sloped in a way to allow for easier installation of the main spray valve and pickup tube into the can by deflecting the pickup tube off the top of the container as it's inserted into the can for installation.

The main shaft of the container is also designed to facilitate a two-way valve that allows the catalyst to be filled into the container and the air to be purged out of it at the same time after the container is already installed into the can. This ability to fill the container once it is already installed in the can will allow for a broader spectrum of products to be filled into the can and a broader spectrum of filling times and procedures.

The invention is illustrated by the accompanying drawings which form a part of this specification, in which:

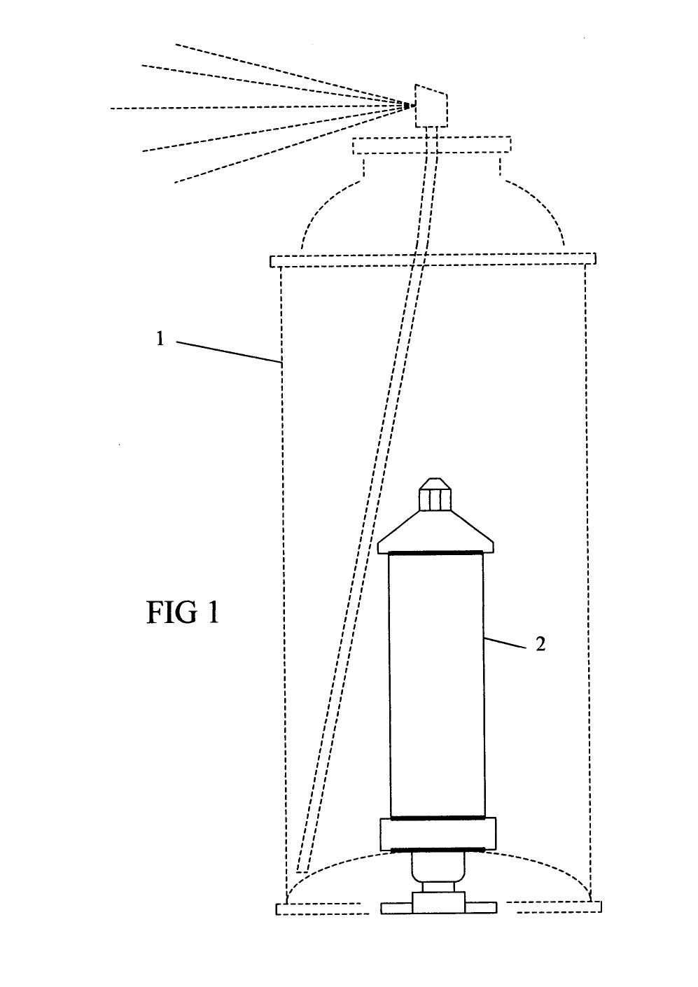

FIG. 1 is a cutaway side view of a standard type aerosol can with a catalyst container mounted in it to show correct orientation with some parts deleted for clarity of illustration;

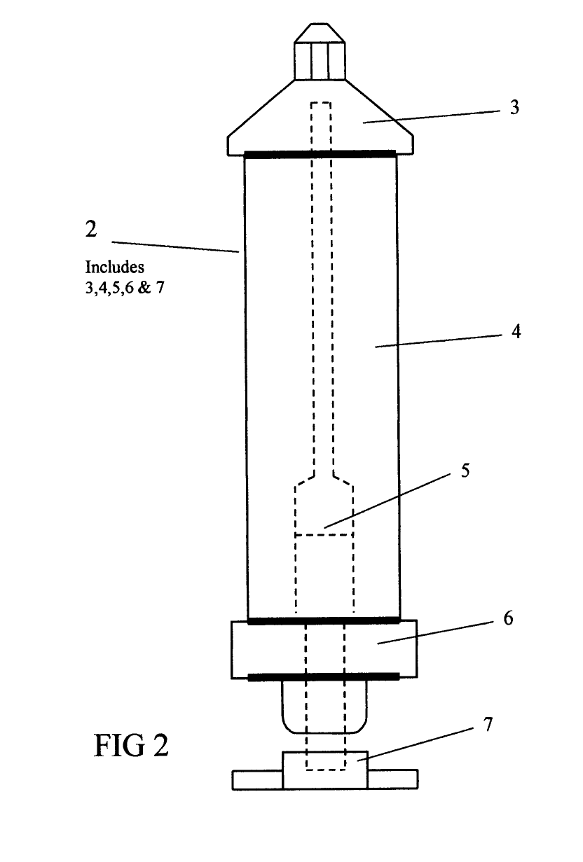

FIG. 2 is a side view of a catalyst container with most of the major parts shown with the actuator shaft shown with dashed lines to show correct orientation.

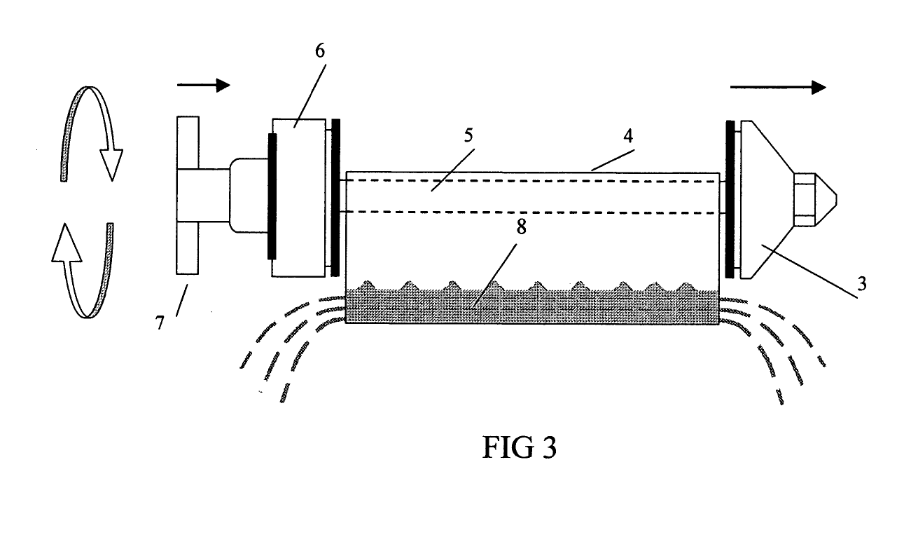

FIG. 3 is a view of the catalyst container with the thumbscrew and actuator shaft screwed in forcing the retaining cap to release it's pressure from the cylinder and therefore allowing the catalyst to flow out.

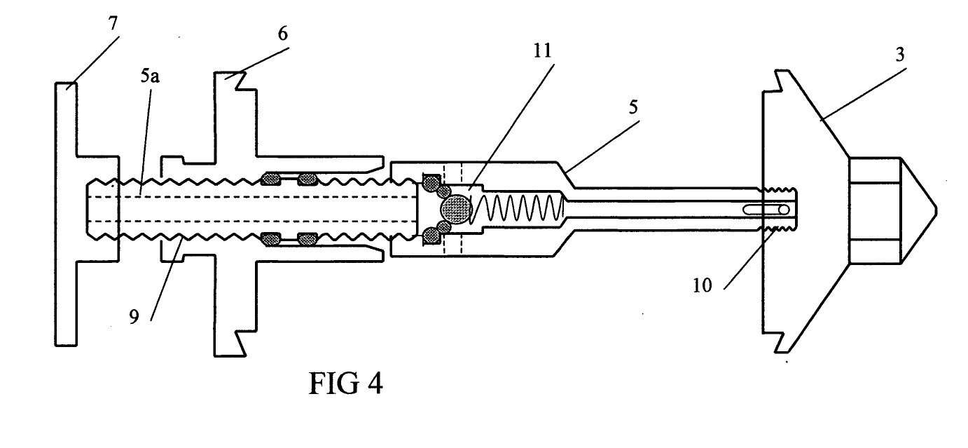

FIG. 4 is a cutaway view of the Catalyst Container showing the correct orientation of the various parts;

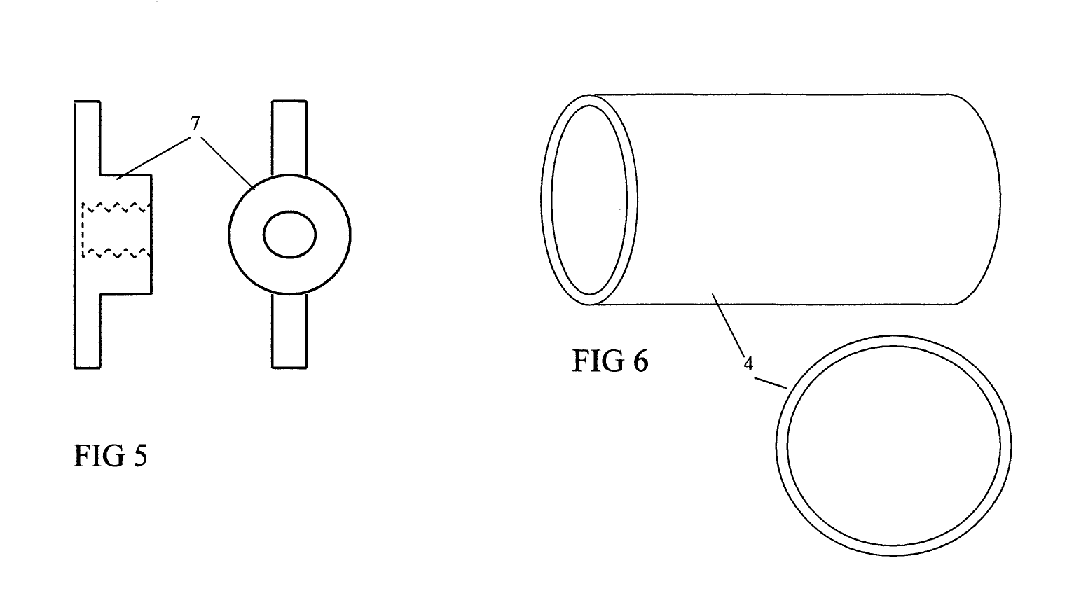

FIG. 5 is a side and end view of the thumbscrew;

FIG. 6 is a side and end view of the cylinder;

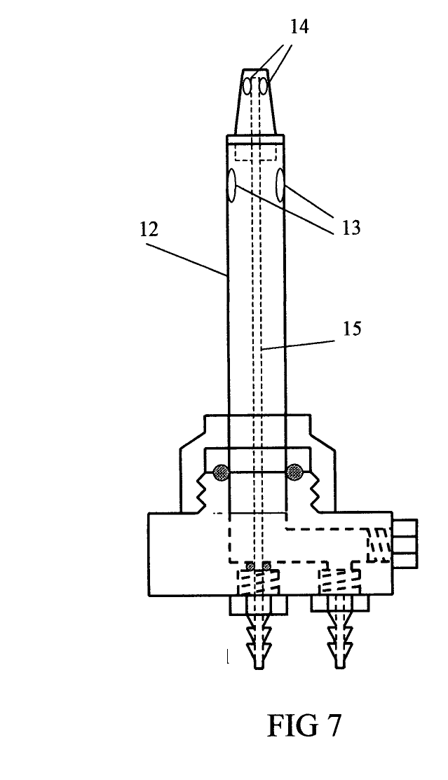

FIG. 7 is a side view of the filler needle that works in conjunction with the two-way valve allowing the container to be filled at the same time the air is purged out of the container.

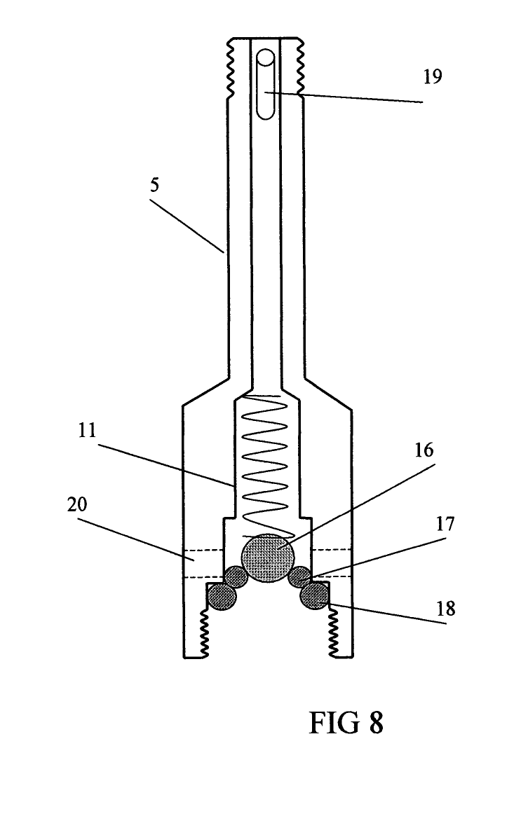

FIG. 8 is a cutaway view of the actuator shaft showing the parts of the two way valve in the closed position as it would be before and after the container has been filled with catalyst;

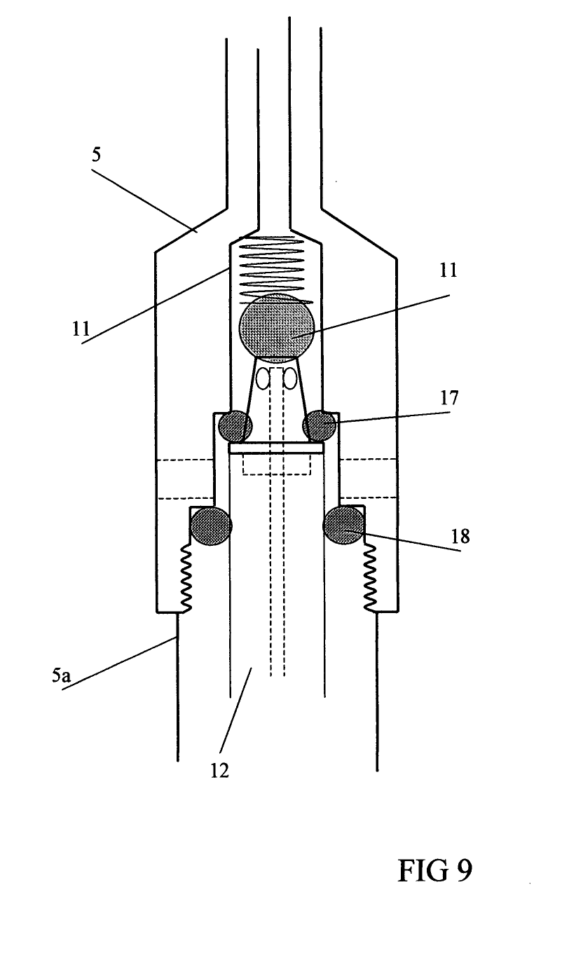

FIG. 9 is a cutaway view the actuator shaft and the intermediate shaft with the filler needle inserted with the two way valve opened during filling.

### DETAILED DESCRIPTION OF THE INVENTION

Referring to the drawings, the catalyzed aerosol assembly comprises a spray can 1, with an internally mounted container for holding catalyst 2,

In the particularly advantageous embodiment of the invention illustrated, the Catalyst Container as shown in FIG. 2, is composed of a retaining cap 3, cylinder 4, actuator and filling shaft 5, base 6, thumbscrew or other type of handle or knob 7, and various other parts and seals to help facilitate the workings of each part.

As shown in FIG. 3, when the thumbscrew 7, is turned or twisted in the right direction, the intermediate actuator shaft 5a, screws into the container base 6, which forces the retainer cap 3, up and away from the cylinder 4, which in turn releases the pressure off the cylinder 4, allowing it to slip over to the side and allows the catalyst 8, to flow out. Once the container has been actuated and open, the paint that is held in the outer spray can 1, can then flow through the cylinder 4, by the user simply shaking the can in a back and forth motion horizontally for a short time to facilitate thorough mixing.

As shown in FIG. 4, when the thumbscrew 7, is turned, it in turn threads the intermediate part of the actuator shaft 5a, into the base 6, by means of threads 9, which in turn causes the main actuator shaft 5, to screw into the retainer cap 3, at a lessor ratio than the threads 9, in the base 6. Because of the greater thread pitch 10, in the cap 3, than the thread pitch 9, in the base 6, the cap 3, will raise at a slower pace than the shaft 5, therefore reducing the amount of twisting pressure needed to open the container 2, to release the cylinder 4, and therefor be much easier for the end-user to release the catalyst 8.

As shown in FIG. 9, the filler needle 12, is inserted into the actuator shaft 5, which opens the two-way valve 11, by moving the sealing ball 16, up creating an opening for the purged air to be returned out the filler needle 12, through the opening created between the sealing ball, 16, and the upper O-ring 17, as the catalyst flows out of the filler needle and into the container between the O-rings 18 and 19.

The materials to be used in the overall construction of the complete assembly will be metals, plastics, rubber seals, and any other materials general found in the construction of aerosol paint cans and small mechanical parts that need to be rust and corrosive free.

Many other parts and functions of this assembly and overall construction were not discussed in detail or discussed very little in this description due to the nature of many parts, designs, functions and construction do not differ or differ very little from designs, and technology already well known and used for many years and therefore considered common knowledge and standard practice in the field of aerosol propelled liquids etc. Some of these functions include but are not limited to; propellant, valves, manufacturing procedures, materials of manufacture, storage, maintenance and means for using the final product. By remaining close to the current aerosol designs, materials of manufacture and manufacturing procedures of today allows this product to be reproduced more readily and also makes it much easier for consumers to understand and operate by being nearly the same as the aerosol paints they are already familiar with.

The invention has been described in detail with particular reference to the embodiments thereof, but it will be understood that variations and modifications can be affected within the spirit and scope of the invention.

The embodiments of the invention in which an exclusive property or privelage is claimed are defined as follows:

1. In an aerosol spray paint can with a specifically manufactured bottom to accept an internally mounted container for holding a measured amount of catalyst. The catalyst container assembly is composed of several components cooperating together, a releasable cylinder that holds the catalyst separate from the paint until the contents are to be used, a hollow actuator shaft that contains a two-way valve and holds the cylinder between a retaining cap and base. A t-nut or other type of handle or knob attached to the end of the actuator shaft that extends out of the bottom of the can that can be easily turned by the end-user to release the contents of the container for mixing with the paint at the time the contents are ready for use. Other than the specifically designed and
manufactured bottom, the rest of the Aerosol Spray Paint Can's design and functions are the same or close to the same as the well known and proven Aerosol Spray Paint Can technology of today.

2. The combination defined in claim 1, wherein the container may be filled at the same time the existing air is purged out of the canister. The main shaft, also called an actuator shaft, is so designed to facilitate a specially designed two-way valve that works in conjunction with a specially designed filling nozzle that allows the catalyst to be filled into the container and the air to be purged out of it at the same time after the container is already installed into the spray can. This ability to fill and purge the catalyst container at the same time after being installed in the spray can will allow for a broader spectrum of products to be filled into the can and a broader spectrum of filling times and procedures.

3. The combination defined in claim 1, wherein the body or main cylinder of the container is held between a cap and a base that spread apart when the thumbscrew or knob is turned which allows for the container to be open at both ends. This design is to so facilitate a thorough mix of the contents with the surrounding paint held within the outer can by allowing the paint to flow through the opened container once the catalyst is released and shaken for a short time by the end-user.

4. The combination defined in claim 1, wherein the end user may easily release the contents of the container by easily turning or twisting the knob or handle attached to the end of the actuator shaft extending out of the bottom of the can. This is accomplished by having two different thread pitches between the retaining cap and base with fewer threads per inch in the base than in the cap. This design allows for the shaft to move farther per turn through the base than the shaft turns into the cap. This thread pitch difference makes it much easier to overcome the internal pressure of a filled aerosol can by allowing the cap of the container to be pushed up at a reduced ratio in relationship to the shaft moving through the base while also allowing the cap to open without rotating, therefore also not having to overcome any friction from the seals between the cylinder and the cap and base. With less pressure needed to be exerted on the shaft to release the catalyst, it will allow the actuation procedure to be much easier for the end-user to accomplish.

5. The combination defined in claim 1, wherein the bottom of the spray can is so designed as to accept a standard mounting cup that the base of the container is pre-installed into. This design for a mounting cup to be installed into the bottom of the spray can will allow for a faster more simple way of installing the catalyst container assembly into the spray can. Other ways to mount the container into the bottom of the spray can may be substituted.

6. The combination defined in claim 1, wherein the top of the container may or may not be sloped in a way to allow for easier installation of the main spray valve and pickup tube into the can by deflecting the pickup tube off the top of the container as it's inserted into the can for installation.
